(19) United States
(12) Patent Application Publication
(10) Pub. No.: US 2026/0122100 A1
(43) Pub. Date: Apr. 30, 2026

(54) DEVICES, SYSTEMS, AND METHODS FOR ATTRIBUTING NETWORK-IMPLEMENTED CYBER ASSETS TO OPERATING ENTITIES AND GENERATING CYBER RISK MITIGATION ACTIONS BASED ON THE ATTRIBUTION

(71) Applicant: BlueVoyant LLC, New York, NY (US)

(72) Inventors: Wayne Chung, Onley, MD (US); Peter M. Gleitz, Arnold, MD (US); Ben Schofield, York (GB)

(73) Assignee: BlueVoyant LLC, New York, NY (US)

(21) Appl. No.: 19/473,822

(22) PCT Filed: Jun. 5, 2024
(86) PCT No.: PCT/US2024/032653

§ 371 Date: Oct. 9, 2025

Related U.S. Application Data
(60) Provisional application No. 63/507,250, filed on Jun. 9, 2023.

(51) Int. Cl. H04L 9/40

(52) U.S. Cl. CPC H04L 63/1433; H04L 63/107; H04L 63/1425

(57) ABSTRACT

A cyber risk management server configured to attribute a network-implemented cyber asset to an operating entity and enhance cyber security of a tenant entity is disclosed herein. The cyber risk management server can include a processor communicably coupled to a source and a memory configured to store algorithmic instructions that, when executed by the processor, cause the cyber risk management server to receive geographic information from the source, receive a plurality of Internet Protocol events associated with a plurality of cyber assets, correlate a Internet Protocol event of the plurality with the received geographic information, attribute the Internet Protocol event to the operating entity based on the correlation, and generate a cyber risk mitigation action configured to enhance the cyber security of the tenant entity based on the attribution of the first Internet Protocol event to the operating entity.

### CROSS-REFERENCE TO RELATED APPLICATIONS

The present application claims the benefit of and priority under 35 U.S. C. § 120 to U.S. Provisional Patent Application No. 63/507,250, titled DEVICES, SYSTEMS, AND METHODS FOR ATTRIBUTING NETWORK-IMPLEMENTED CYBER ASSETS TO OPERATING ENTITIES AND GENERATING CYBER RISK MITIGATION ACTIONS BASED ON THE ATTRIBUTION, filed Jun. 9, 2023, the disclosure of which is incorporated by reference in its entirety herein.

### FIELD

The present disclosure is generally related to network security, and, more particularly, is directed to improved devices, systems, and methods for autonomously and accurately identifying an entity operating a cyber asset on a network and enhancing cyber security by implementing cyber risk mitigation actions based on the identified entity and an assessed risk.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a cyber risk management server configured to attribute a network-implemented cyber asset to an operating entity and enhance cyber security of a tenant entity is disclosed. The cyber risk management server can include a processor communicably coupled to a source and a memory configured to store algorithmic instructions that, when executed by the processor, cause the cyber risk management server to receive geographic information from the source, receive a plurality of Internet Protocol events associated with a plurality of cyber assets, wherein the Internet Protocol events are enriched with location information, correlate an Internet Protocol event of the plurality with the received geographic information, attribute the first Internet Protocol event to the operating entity based on the correlation, and generate a cyber risk mitigation action configured to enhance or manage the cyber security of the tenant entity based on the attribution of the Internet Protocol event to the operating entity.

In various aspects, a computer-implemented method of attributing a network-implemented cyber asset to an operating entity and enhancing cyber security of a tenant entity based on the attribution via a cyber risk management provider server is disclosed. The computer-implemented method can include receiving, via a processor of the cyber risk management server, geographic information from a source, receiving, via the processor, a plurality of Internet Protocol events associated with a plurality of cyber assets, wherein the Internet Protocol events are enriched with location information, correlating, via the processor, a first Internet Protocol event of the plurality of Internet Protocol events with the received geographic information, attributing, via the processor, the Internet Protocol event to the operating entity based on the correlation, and generating, via the processor, a cyber risk mitigation action for the tenant entity, wherein the cyber risk mitigation action is configured to enhance or manage the cyber security of the tenant entity based on the attribution of the first Internet Protocol event to the operating entity.

In various aspects, a system configured to attribute a network-implemented cyber asset to an operating entity and enhance or manage cyber security of a tenant entity based on the attribution is disclosed. The system can include a source configured to store entity-related geographic information, and a cyber risk management server including a processor communicably coupled to the tenant entity the source, and a memory configured to store algorithmic instructions that, when executed by the processor, cause the cyber risk management server to receive the geographic information from the source, receive a plurality of Internet Protocol events associated with a plurality of cyber assets, wherein the Internet Protocol events are enriched with location information, correlate a first Internet Protocol event of the plurality of Internet Protocol events with the received geographic information, attribute the first Internet Protocol event to the operating entity based on the correlation, and generate a cyber risk mitigation action for the tenant entity, wherein the cyber risk mitigation action is configured to enhance the cyber security of the tenant entity based on the attribution of the first Internet Protocol event to the operating entity.

These, and other objects, features, and characteristics of the present disclosure, as well as the methods of operation, and functions of the related elements of structure, and the combination of parts, and economies of manufacture, will become more apparent upon consideration of the following description, and the appended claims with reference to the accompanying drawings, all of which form a part of this specification, wherein like reference numerals designate corresponding parts in the various figures. It is to be expressly understood, however, that the drawings are for the purpose of illustration, and description only, and are not intended as a definition of the limits of the disclosure.

### BRIEF DESCRIPTION OF THE DRAWINGS

Various features of the aspects described herein are set forth with particularity in the appended claims. The various aspects, however, both as to organization, and methods of operation, together with advantages thereof, may be understood in accordance with the following description taken in conjunction with the accompanying drawings as follows:

FIG. 1 illustrates a diagram of a system configured to attribute a network-implemented cyber asset to an operating entity, in accordance with at least one non-limiting aspect of the present disclosure;

FIG. 2 illustrates a logic flow diagram of a method of attributing a network-implemented cyber asset to an operating entity, in accordance with at least one non-limiting aspect of the present disclosure;

FIG. 3 illustrates a logic flow diagram of another method of attributing a network-implemented cyber asset to an operating entity, in accordance with at least one non-limiting aspect of the present disclosure;

FIG. 4 illustrates a graphical representation of several outputs generated via the method of FIG. 3, in accordance with at least one non-limiting aspect of the present disclosure;

FIG. 5 illustrates a graphical representation of several outputs generated via the methods of FIGS. 2 and 3, in accordance with at least one non-limiting aspect of the present disclosure;

FIG. 6 illustrates a block diagram of a computing system, in accordance with at least one non-limiting aspect of the present disclosure.

Corresponding reference characters indicate corresponding items throughout the several views. The exemplifications set out herein illustrate various aspects of the present disclosure, in one form, and such exemplifications are not to be construed as limiting the scope of the present disclosure in any manner.

### DETAILED DESCRIPTION

The Applicant of the present application owns the following U.S. Provisional Patent Applications, the disclosure of each of which is herein incorporated by reference in its entirety:
U.S. Provisional Patent Application No. 63/294,570 titled DEVICES, SYSTEMS, AND METHODS FOR PROVISIONING AND UPDATING SECURITY INFORMATION & EVENT MANAGEMENT ARTIFACTS FOR MULTIPLE TENANTS, filed on Dec. 29, 2021;
U.S. Provisional Patent Application No. 63/295,150 titled DEVICES, SYSTEMS, AND METHODS FOR STREAMLINING AND STANDARDIZING THE INGEST OF SECURITY DATA ACROSS MULTIPLE TENANTS, filed on Dec. 30, 2021;
U.S. Provisional Patent Application No. 63/302,828 titled DEVICES, SYSTEMS, AND METHODS FOR REMOTELY MANAGING ANOTHER ORGANIZATION'S SECURITY ORCHESTRATION, AUTOMATION, AND RESPONSE, filed on Jan. 25, 2022;
U.S. Provisional Patent Application No. 63/313,422 titled DEVICES, SYSTEMS, AND METHODS FOR IDENTIFYING CYBER ASSETS AND GENERATING CYBER RISK MITIGATION ACTION BASED ON DOMAIN REDIRECTS, filed on Feb. 24, 2022;
U.S. Provisional Patent Application No. 63/341,264 titled DEVICES, SYSTEMS, AND METHODS FOR SUMMARIZING ANALYTIC OBSERVATIONS, filed on May 12, 2022;
U.S. Provisional Patent Application No. 63/344,305 titled DEVICES, SYSTEMS, AND METHODS FOR INGESTING & ENRICHING SECURITY INFORMATION TO AUTONOMOUSLY SECURE A PLURALITY OF TENANT NETWORKS, filed on May 20, 202;
U.S. Provisional Patent Application No. 63/345,679 titled DEVICES, SYSTEMS, AND METHODS FOR IDENTIFYING CYBER ASSETS AND GENERATING CYBER RISK MITIGATION ACTIONS BASED ON A DEMOCRATIC MATCHING ALGORITHM, filed on May 25, 2022
International Patent Application No. PCT/US22/72739, titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS, filed on Jun. 3, 2022;
International Patent Application No. PCT/US22/72743, titled DEVICES, SYSTEMS, AND METHODS FOR STANDARDIZING & STREAMLINING THE DEPLOYMENT OF SECURITY INFORMATION & EVENT MANAGEMENT ARTIFACTS FOR MULTIPLE TENANTS, filed on Jun. 3, 2022;
U.S. Provisional Patent Application No. 63/365,819 titled DEVICES, METHODS, AND SYSTEMS FOR GENERATING A HIGHLY-SCALABLE, EFFICIENT COMPOSITE RECORD INDEX, filed on Jun. 3, 2022
U.S. Provisional Patent Application No. 63/353,992 titled DEVICES, SYSTEMS, AND METHODS FOR CATEGORIZING, PRIORITIZING, AND MITIGATING CYBER SECURITY RISKS, filed on Jun. 21, 2022;
U.S. Provisional Patent Application No. 63/366,903 titled DEVICES, SYSTEMS, AND METHOD FOR GENERATING AND USING A QUERYABLE INDEX IN A CYBER DATA MODEL TO ENHANCE NETWORK SECURITY, filed on Jun. 23, 2022;
U.S. Provisional Patent Application No. 63/368,567 titled DEVICES, SYSTEMS, AND METHODS FOR UTILIZING A NETWORKED, COMPUTER-ASSISTED, THREAT HUNTING PLATFORM TO ENHANCE NETWORK SECURITY, filed on Jul. 15, 2022;
U.S. Provisional Patent Application No. 63/369,582 titled AUTONOMOUS THREAT SCORING AND SECURITY ENHANCEMENT, filed on Jul. 27, 2022; and
U.S. Provisional Patent Application No. 63/377,304 , titled DEVICES, SYSTEMS, AND METHODS FOR CONTINUOUSLY ENHANCING THE IMPLEMENTATION OF CODE CHANGES VIA ENRICHED PIPELINES, filed on Sep. 27, 2022.

Numerous specific details are set forth to provide a thorough understanding of the overall structure, function, manufacture, and use of the aspects as described in the disclosure, and illustrated in the accompanying drawings. Well-known operations, components, and elements have not been described in detail so as not to obscure the aspects described in the specification. The reader will understand that the aspects described, and illustrated herein are non-limiting aspects, and thus it can be appreciated that the specific structural, and functional details disclosed herein may be representative, and illustrative. Variations, and changes thereto may be made without departing from the scope of the claims.

Before explaining various aspects of the systems, and methods disclosed herein in detail, it should be noted that the illustrative aspects are not limited in application or use to the details disclosed in the accompanying drawings, and description. It shall be appreciated that the illustrative aspects may be implemented or incorporated in other aspects, variations, and modifications, and may be practiced or carried out in various ways. Further, unless otherwise indicated, the terms, and expressions employed herein have been chosen for the purpose of describing the illustrative aspects for the convenience of the reader, and are not for the purpose of limitation thereof. For example, it shall be appreciated that any reference to a specific manufacturer, software suite, application, or development platform disclosed herein is merely intended to illustrate several of the many aspects of the present disclosure. This includes any, and all references to trademarks. Accordingly, it shall be appreciated that the devices, systems, and methods disclosed herein can be implemented to enhance any software update, in accordance with any intended use, and/or user preference.

As used herein, the term “server” may refer to or include one or more computing devices that are operated by or facilitate communication, and processing for multiple parties in a network environment, such as the Internet or any public or private network. Reference to “a server” or “a processor,” as used herein, may refer to a previously-recited server, and/or processor that is recited as performing a step or function, a different server, and/or processor, and/or a combination of servers, and/or processors.

As used herein, the term “entity” may refer to or include a company, a business-related organization, a non-profit organization, a governmental organization, a charitable organization, an educational institution, or any other type of organization or individual that may own or have an association with a collection of cyber assets. Reference to a “cyber asset,” as used herein, may refer to a computing device, a network, hardware, software, data, information, or any other type information technology-related component, label, or identifier for switching, signaling, or routing such as, for example, a domain, an Internet Protocol (“IP”) address, or a shared and/or dynamic asset.

As used herein, the term “geographic information” may refer to or include coordinates, street addresses, building outlines, and/or any other information, data, and/or metadata commonly used in relation to a geographical position. For example, geographic information can include any information used by a geographic information system (“GIS”) to attribute data to a geographic location. Geographic information, as specifically used herein, can include any information used to associate an IP address to an entity and/or a position of an entity.

As used herein, the terms “domain” and “domain name” may refer to or include a string that identifies or is otherwise associated with a network, computing device, or other resource in communication with the Internet, such as, for example a server, personal computer, website, or other service communicated via the Internet. In some aspects, as used herein, “domain” and “domain name” may generally refer to domain names as they are described in Domain Names—Implementation and Specification, NETWORK WORKING GROUP (Nov. 1987), https://datatracker.ietf.org/doc/html/rfc1035, the disclosure of which is incorporated by reference herein.

As used herein, the term “Internet Protocol Addess” or “IP Address” can include a numerical label that is connected to a computer network that uses an Internet Protocol for communication. An IP address can provide network interface identification and may include a host-to-host protocol on the Internet. For example, an IP Address can include RFC 791 or RFC 2460.

As used herein, the term “tenant” or “tenant entity” can include an individual or organizational client of a cyber security risk manager. For example, a tenant or tenant entity may hire a cyber security risk manager to identify and mitigate risks to one or more cyber assets owned and operated by the tenant. As used herein, the term “operating entity” can include an individual or organizational third party relative to a tenant or tenant entity, that the cyber security risk manager is monitoring for risk. It shall be appreciated that a tenant or tenant entity can receive reports and/or actions related to their own cyber assets and/or an operating entity, as generated via a cyber security risk manager using the devices, systems, or methods disclosed herein.

It shall be appreciated that entities generally have a basic need to understand and manage cyber security risks. More specifically, entities have a need to understand and manage cyber security risks related to their cyber assets. For example, an entity (e.g., a company, a non-profit organization, a governmental organization, etc.) can have an Internet presence—a large collection of cyber assets that are used for Internet-related communications. One or more of these cyber assets may be configured such that the entity is potentially exposed to cyber threats. Cyber threats can include unwanted or malicious attempts to gain access to or adversely control the entity's networks, data, and/or other information. Cyber threats may also include malicious denial of usage of cyber assets by their rightful owners, for example denial-of-service attacks, or ransomware. Thus, in order to identify potential exposure to cyber threats, and to take action against such threats, entities and/or their risk evaluators and auditors have a need to identify their cyber assets and how they are configured.

In order to further improve the management of cyber threats and other security risks, entities also have a need to identify and understand the cyber assets of other entities. This need may arise because the communication between entities could lead to threat exposure or perhaps because the cyber security risks of an entity could cause a catastrophic service failure outside the realm of the Internet with adverse implications for partner entities. For example, a first entity may use its cyber assets to communicate with the cyber assets of another entity. If the cyber assets of the other entity are susceptible to cyber threats, then communicating with these assets could put the first entity at risk. Therefore, entities have a need not only to identify and understand their own cyber assets, but also to identify and understand the risks posed by cyber assets of other entities. Moreover, once a particular entity is identified as being of interest, it can be complex and resource-intensive to identify some or all the cyber assets that are owned and/or controlled by that entity. For example, a type of cyber asset that can be important to identify when analyzing cyber risk are IP addresses, which are generally used as a primary identifier of a cyber asset operating on a network.

The Internet Assigned Numbers Authority (“IANA”) has the overall responsibility for managing the IP address pool and delegates large blocks of addresses to Regional Internet Registries (“RIRs”) for registration. RIRs manage, distribute, and publicly register IP addresses and other related Internet number related resources, such as Autonomous System Numbers (“ASN”) and reverse Domain Name System (DNS) delegations within their respective regions. Although certain cyber assets connected to a particular network can sometimes be identified via device identifying information, including an assigned netrange or IP address, the identification of entities and their cyber assets can be easily obfuscated. For example, when registering an IP address, generic registration information and—in some instances—third party registrants can be utilized, which can render it difficult to discern which entities are actually operating cyber assets assigned to a particular IP address. Thus, accurately identifying the entity operating a particular cyber asset based on a registered IP address can become a difficult or impossible task. As would be expected, this process of identification can become increasingly complex, time-consuming, and resource-intensive at scale, as the number of entities and their corresponding cyber assets being monitored increases. Thus, in order to accurately attribute a a cyber asset (e.g., a computing device) or activity to an operating entity via cyber asset identifying information (e.g., an IP address), there is a need to accurately attribute network-implemented cyber assets to operating entities and generating cyber risk mitigation actions based on the attribution.

However, conventional devices, systems, and methods fail to achieve such benefits accurately, autonomously, and efficiently. Analyzing each IP address to identify a potential association with an entity is a task of such scope, scale, and complexity that it cannot be practically performed by the human mind. Moreover, as previously described, difficulty can arise when analyzing IP addresses for a potential association with an entity because registration information can often be incomplete, incorrect, or purposely redacted. As an example, the registration information for a particular IP address may only include a person's name and a phone number, but no other information that could be used to confirm an association with a particular entity. As another example, the name, phone number, or other information included in the registration information may contain spelling errors or typos (e.g. “Willims Computing” [sic] instead of “Williams Computing”; “123-465-7890” instead of “123-456-7890”). Thus, a security analyst tasked with identifying, analyzing, and/or managing the cyber assets of multiple entities is prone to misclassifying and/or never discovering relevant domain names. Moreover, contracting a security analyst to perform this task can be costly because of the effort and complexity involved.

Misattributing or misunderstanding who is operating a particular cyber asset of interest during an investigation can be detrimental to the cyber security risk analysis and mitigation process. As explained above, cyber assets may be configured such that they are potentially exposed to cyber threats. If a cyber asset (e.g., an IP address) of a particular entity is exposed to a cyber threat but is also never identified as belonging to the entity, then the cyber security evaluation of that entity could be inaccurate and incomplete. Moreover, because the exposed cyber asset is never identified, it may be difficult or impossible for the evaluated entity, or other entities potentially communicating or otherwise doing business with the evaluated entity, to implement an action to mitigate the potential cyber threat. For example, it may be desirable to implement a configuration change in response to determining that a cyber asset is exposed to a cyber threat. However, if the cyber asset is never identified, the configuration change may not be implemented. Accordingly, there is a need for improved devices, systems, and methods for reliably identifying entities with an Internet presence, narrowing the hundreds of millions of registered IP addresses to a manageable set that can be analyzed for a potential association with the identified entities, and generating cyber risk mitigation actions based on the analysis. Such enhancements could reduce the resources required to identify the cyber assets belonging to a particular entity while also improving accuracy. Additionally, such enhancements could allow for the automated implementation of cyber risk mitigation actions. Accurately attributing an IP address to an operating entity can also be extremely useful for commercial related activities (e.g., sales, marketing, etc.).

For example, such automated devices, systems, and methods can be configured to acquire and aggregate information—including geographic information (e.g., geographic coordinates, street addresses, or building outline, etc.)—from various sources, process that information in conjunction with other information to attribute a particular IP address to a particular entity, in spite of any generic registration information or third party obfuscation that could otherwise complicate true registrant identification. Whereas conventional devices, systems, and methods are not technologically configured to access and locate geographic information, conventional devices, systems, and methods are technologically incapable of attributing an IP address to a registered entity based on geographic information. The devices, systems, and methods disclosed herein provide a technological improvement in the ability to identify, acquire, and integrate geographic information to attribute IP addresses of interest to the entities using them with accuracy and precision in spite of any third party registrant, generic registration information, or any other inadequate registration specificity. In summary, the devices, systems, and methods described herein can be configured to assimilate geographic information emitted by or otherwise derived or available from electronic equipment associated with a particular IP address with information associated with a particular entity's geographic location to attribute that particular IP addresses with their operational entity and drive technological benefits.

For example, the devices, systems, and methods described herein can provide an enhanced mitigation of cyber security risks, as they enable an implementing organization to identify the entity operating a computing device on a network with improved clarity. Misattributing an IP address during the investigation of suspicious activity can be detrimental to the cyber security risk analysis and mitigation process. As explained above, network and/or computing devices operating on the network can be potentially exposed to cyber threats from devices operated by a misattributed entity. Absent the devices, systems, and methods disclosed herein, the network may remain exposed to the cyber threat and the cyber security evaluation of that entity could be inaccurate and incomplete. Moreover, if the exposed cyber asset were never identified, it would be difficult or impossible for the implementing user, or other entities potentially communicating or otherwise doing business with the implementing user, to implement an action to mitigate the potential cyber threat. For example, it may be desirable to implement a configuration change in response to determining that a particular computing device is registered to a malicious (or maliciously compromised) actor and/or entity. If the cyber asset is never identified, the configuration change may not be implemented. Accordingly, there is a need for the devices, systems, and methods disclosed herein, which can identify a large number of entities operating a large number of computing devices on a network, narrowing a large number IP address registrants to a manageable set of IP address registrants for investigation and any associated risk evaluation and mitigation. Such enhancements can reduce the resources required to identify the registrant of a particular computing device while also improving accuracy. Additionally, such enhancements could allow for the automated implementation of cyber risk mitigation actions.

Although the aforementioned benefits may be achieved algorithmically, it shall be appreciated that any algorithmic methods are integrated into a practical application by the devices, systems, and methods described herein. Moreover, the computational implementation of such algorithmic methods, as will be described in further detail herein, enables an implementing user to continuously and simultaneously monitor an extremely large number of IP addresses in a manner that would be otherwise impractical.

The present disclosure presents devices, systems, and methods for reliably attributing cyber assets (e.g., IP addresses) to a particular operating entity, and/or implementing cyber risk mitigation actions based on such attributions. These devices, systems, and methods can provide many technological benefits, such as, for example: (1) more accurately attributing an IP address to an operating entity, in a non-routine way, by generating a list of candidate IP addresses and geographic information, fetching supplemental information from a source, and attributing the candidate IP addresses to particular operating entities based on the supplemental information; (2) attributing a subset of a large number of registered IP addresses of interest an operating entity of interest, resulting in a more manageable list of addresses of interest for continued monitoring and/or consideration—thereby attributing IP addresses to an operating entity at a scale and in a manner that cannot be practically performed by the human mind; and/or (3) integrating the accurate attribution of cyber asset operating under an IP address to an operating entity into a practical application by generating an automated cyber risk mitigation action based on the attribution and a risk assessment of the operating entity, itself.

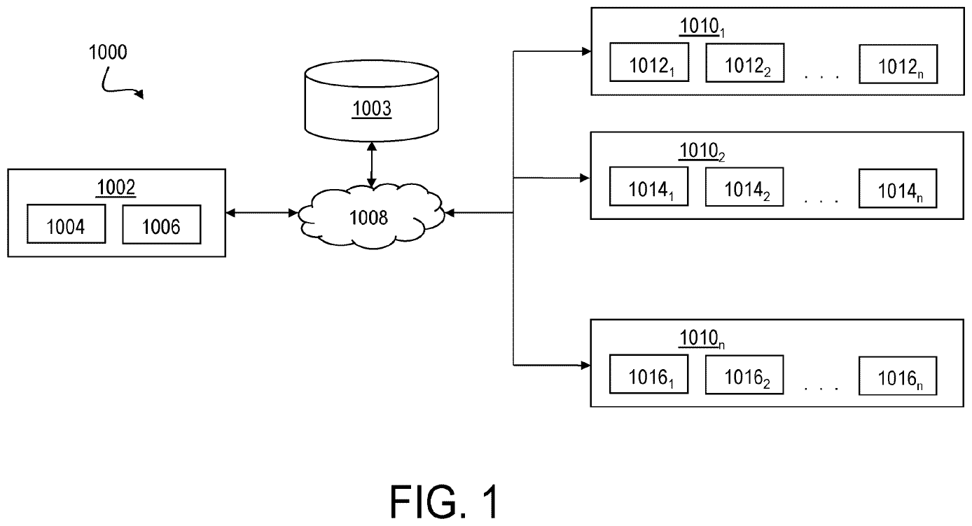

Referring now to FIG. 1, a diagram of a system 1000 configured to attribute a network-implemented device to an operating entity is depicted in accordance with at least one non-limiting aspect of the present disclosure. In summary, the system 1000 of FIG. 1 is particularly configured to employ an analytic technique to facilitate “footprinting,” which is a cyber security process of gathering and associating to an entity as much relevant data about a cyber asset, entity, network, and/or event as is possible to characterize, attribute to a target, and subsequently mitigate cyber threats. The system 1000 of FIG. 1, therefore, is particularly configured to provide specific results for determining the IP addresses used by an entity under examination for cyber security vulnerabilities. According to some non-limiting aspects, the system 1000 can be implemented as a sub-system and configured to attribute IP addresses to entities on behalf of a larger, more complex system.

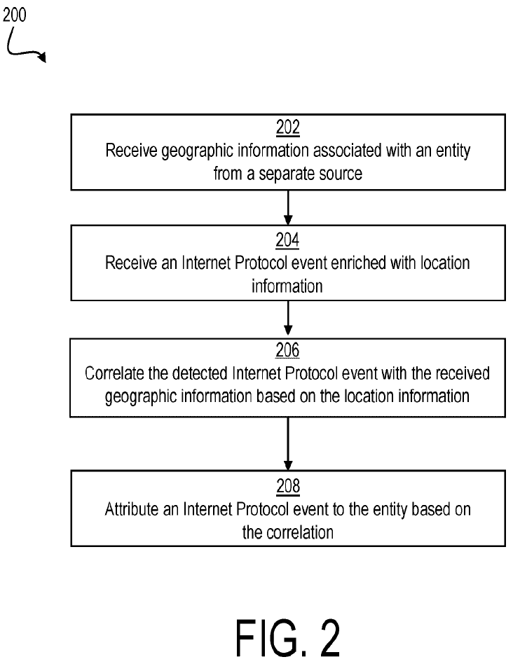

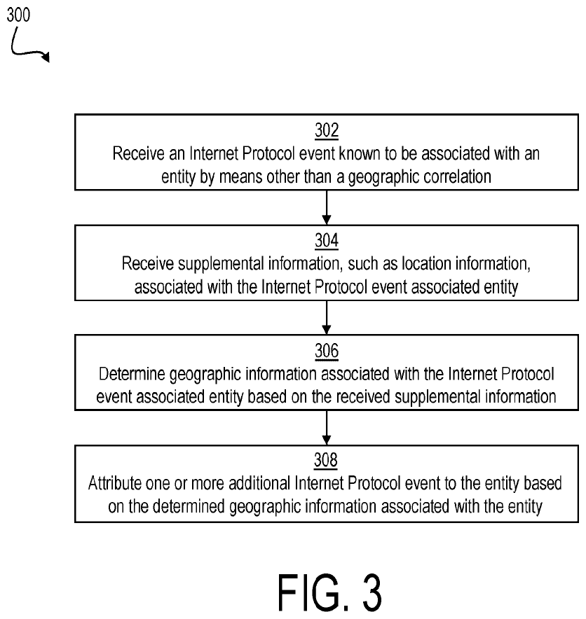

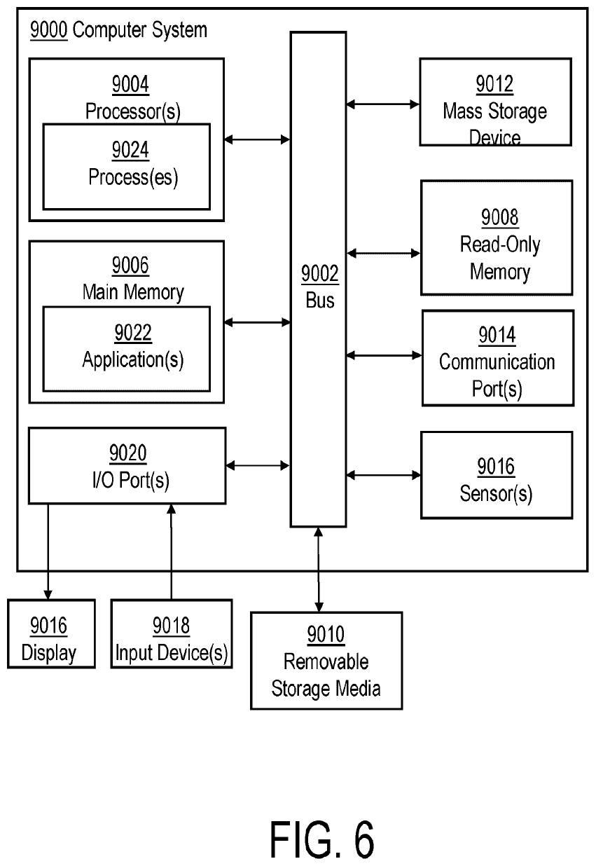

According to the non-limiting aspect of FIG. 1, the system 1000 can include a cyber risk management server 1002 comprising a memory 1004 and a processor 1006. In various aspects, cyber risk management server 1002 can comprise the computer system 9000 and the various components thereof (e.g., processor 1006 can be similar to processor(s) 9004, memory 1004 can be similar to main memory 9006, etc.), as will be discussed in further reference to FIG. 6. The memory 1004 may be configured to store instructions that, when executed by processor 1006, carry out various aspects of the methods 200 (FIG. 2), 300 (FIG. 3) and processes 600 (FIG. 6), 700 (FIG. 7) described below. The cyber risk management server 1002 can be communicably coupled, via network 1008, to a plurality of entities 1010₁, 1010₂ . . . 1010ₙ. Each entity 1010₁, 1010₂ . . . 1010ₙ of the plurality can represent a tenant (e.g., a customer organization) contracting with the cyber risk management provider for cyber security services and/or an entity that may be evaluated by the cyber risk management provider for cyber threats. According to a non-limiting aspect of FIG. 1, the network 1008 can include any variety of wired, long-range wireless, and/or short-range wireless networks. For example, the network 1008 can include an internal network, a Local Area Network (LAN), WiFi®, cellular networks, near-field communication (hereinafter “NFC”), amongst others.

In further reference to FIG. 1, each entity 1010₁, 1010₂ . . . 1010ₙ of the plurality can host and/or be associated with one or more instances of one or more cyber assets 1012, 1014, 1016 (sometimes referred to herein as clients 1012, 1014, 1016). For example, a first entity 1010₁ can include one or more machines implementing or otherwise associated with one or more cyber assets 1012₁, 1012₂ . . . 1012ₙ, a second tenant 1010₂ can include one or more machines implementing or otherwise associated with one or more cyber assets 1014₁, 1014₂ . . . 1014ₙ, and/or a third tenant 1010ₙ can include one or more machines implementing or otherwise associated with one or more cyber assets 1016₁, 1016₂ . . . 1016ₙ. Each entity 1010₁, 1010₂, . . . 1010ₙ can include an intranet (e.g., a network) by which each machine can communicate. As mentioned above, each entity 1010₁, 1010₂, . . . 1010ₙ can represent a tenant (e.g., customer), such as an organization, contracting with the cyber risk management provider for security services. Accordingly, the cyber risk management server 1002 can be configured to have oversight over one or more of the entities 1010₁, 1010₂, and 1010ₙ of the plurality, and thus, can responsible for monitoring and/or managing an entity's cyber assets (e.g., 1012, 1014, 1016) in order to mitigate cyber security threats. For example, in order to properly manage cyber security threats, the cyber risk management provider may seek to attribute a cyber asset (e.g., IP address) to a third party operating entity (not shown) to understand who is operating on or interfacing with the tenant's network.

However, as previously discussed, identifying the cyber assets (e.g., 1012, 1014, 1016) of a plurality of entities (e.g. 1010₁, 1010₂, . . . 1010ₙ) by a cyber risk management provider (e.g. using cyber risk management server 1002) can be a complex and resource-intensive process. Furthermore, certain cyber assets 1012, 1014, 1016 can be controlled by a non-tenant 1010₁₋ₙ operating entity even though they have accessed a tenant entity 1010₁₋ₙ network, thereby posing a risk to the tenant's 1010₁₋ₙ cyber security. Moreover, misclassifying and omitting cyber assets of a particular entity can be detrimental to the cyber security risk mitigation process. As such, the system 1000—and more specifically, the cyber risk management server 1002—of FIG. 1 can store one or more particularly configured algorithms in memory 1004 that, when executed by the processor 1006, cause the cyber risk management server 1002 to utilize supplemental information (e.g., network information and geographic information connected to advertising data, endpoint software development kit data, mapping data, etc.) to accurately associate the use of an IP address, via geographic information, to its operating entity or organization. For example, network information can include a WiFi name, a Service Set Identifier (“SSID”), and/or net ranges, amongst others. According to the non-limiting aspect of FIG. 1, the system 1000 can further include one or more sources 1003 configured to store supplemental information that can be used by the cyber risk management server 1002 to attribute IP events of network-implemented, cyber asset devices to an operating entity. As will be described in further reference to the processes 600, 700 of FIGS. 6 and 7, an IP event can include a discrete piece of information emitted by a cyber asset on a network identified via network information (e.g., a WiFi name, a SSID, net ranges, etc.), wherein the cyber asset is assigned cyber asset identifying information (e.g., an IP address, a domain, etc.), which identifies the cyber asset device on the network.

According to some non-limiting aspects, the one or more sources 1003 of FIG. 1 can store supplemental information, including registration data, network identifiers and networking constraints, timing information, host r geolocation, and information available via online advertising, all of which can be used to contextualize IP events in conjunction with geographic information. For example, the cyber risk management server 1002 can begin with a list of IP events (e.g., at least one protocol and at least one IP address, but possibly including other related IP addresses and/or ports, etc.), which can be connected to supplemental information provided by the one or more sources 1003 that enriches the IP events and assists a cyber risk management provider with context for the IP events. Such supplemental information can include, according to various non-limiting aspects, a handset identifier, networking information (e.g., an SSID, ethernet address(es), bluetooth addresses, VPN identifiers, network registration information, etc.), routing consolidation identifiers like Autonomous System Numbers (“ASNs”) and/or associated ASN registration information. Supplemental information can further include non-networking elements such as domain names, Software Development Kit (“SDK”) identifiers, and/or Ad Exchange identifiers, amongst others.

According to the non-limiting aspect of FIG. 1, the source 1003 can communicate with the cyber risk management server 1002 via an application and/or application program interface (“API”)—accessed via the cyber risk management server 1002. Of course, the cyber risk management server 1002 can be configured to access the one or more sources 1003 via any conventional means related to the network 1008. Network connection identifiers, such as IP addresses, MAC addresses, SSIDs, Bluetooth addresses, may be unavailable from other forms of supplemental information and sources 1003. According to other non-limiting aspects, the supplemental information can include Ad Exchange data. Certain of the sources 1003 referenced above may produce more results, but may require significant filtering or analytic efforts by the cyber risk management server 1002 to get to the correct results depending on user preference and/or intended application. Other sources 1003 referenced above may produce sparser—albeit, more relevant—data depending on user preference and/or intended application. Therefore, it shall be appreciated that different types of supplemental information can be extracted from one or many sources 1003 and each type of supplemental information can provide its own, unique context for one or more IP events. For example, according to some non-limiting aspects, more than one source 1003 can be used in combination by the system 1000 of FIG. 1, as the supplemental information provided by each may be complementary and further enhance efficiency and accuracy of results and thus, improve overall effective system 1000 security.

According to some non-limiting aspects, the one or more sources 1003 of FIG. 1 can further store supplemental information that includes geographic information (e.g., geographic coordinates, street addresses, or building outline, etc.) that can be used to identify an operating entity and attribute the identified operating entity to an IP event (e.g., IP address) associated with a network-implemented device. According to some non-limiting aspects, the one or more sources 1003 can include one or more databases configured to support geographic queries, which can further improve the efficiency of the algorithmic processing executed by the cyber risk management server 1002. According to other non-limiting aspects, the one or more sources 1003 can include information from the Domain Name System (“DNS”), as will be described in further detail herein.

The cyber risk management server 1002 of FIG. 1 can acquire supplemental information from the one or more sources 1003 to enhance the attribution of an IP event to an entity via the methods 200, 300 (FIGS. 2 and 3) disclosed herein, thereby enhancing the cyber security of a tenant 1010₁₋ₙ. In other words, the cyber risk management server 1002 can acquire and combine geographic information with other information to improve the precision and recall of an IP address attribution to an operating entity. Moreover, the methods 200, 300 (FIGS. 2 and 3) disclosed herein are particularly configured configured to scale these functions for an unprecedented number of tenant entities 1010₁, 1010₂ . . . 1010ₙ and/or cyber assets 1012₁, 1012₂, . . . 1012ₙ efficiently, thereby reducing the number of computing resources required by the cyber risk management server 1002 and enhancing the security of the overall system 1000. The disclosure will now turn to the various methods 200, 300 (FIGS. 2 and 3) for identifying the cyber assets of a plurality of entities and generating cyber risk mitigation actions based on the identified assets.

Referring now to FIG. 2, a logic flow diagram of a method 200 of attributing a network-implemented cyber asset to an operating entity is depicted in accordance with at least one non-limiting aspect of the present disclosure. For example, the method 200 of FIG. 2 can be algorithmically implemented via the cyber risk management server 1002 of the system 1000 of FIG. 1. According to the non-limiting aspect of FIG. 2, the method 200 can include receiving 202 geographic information associated with an entity. For example, the geographic information can include an address (e.g., a street address of an office owned by the entity, etc) and/or geographic coordinates (e.g., latitude, longitude, altitude, geographic encoding schemes such as northings and eastings, a geohash, etc.), amongst others. It shall be appreciated that the geographic information can define a geographic location and/or area associated with the entity. For example, according to the non-limiting aspect wherein the geographic information includes a geohash, the entity may be located within a cell defined by the geohash. According to some non-limiting aspects, the cyber risk management server 1002 (FIG. 1) can receive the geographic information from the source 1003 (FIG. 1), which may be hosted by a third party.

In further reference to FIG. 2, the method 200 can further include receiving 204 Internet Protocol events enriched with location information. For example, an Internet Protocol can include a protocol, such as addressing and multiplexing mechanisms (e.g., IP address and port) or one or more sets of rules, for routing and addressing packets of data so that they can travel across networks and arrive at the correct destination. IP events can be generated by any number of cyber assets (e.g., personal computers, laptop computers, mobile phones, tablets, Internet of Things devices, etc.) assigned an IP address in association with a connection to a network, by which the cyber assets transmit and/or receive packets of data from the geographic location and/or area defined by the enriched location information. For example, according to some non-limiting aspects, a mobile device can send its location to a ride sharing application, or an IoT device can communicate its location to a controlling server. In either aspect, such data can be mined and used by the devices, systems, and methods disclosed herein to associate the device's location to its Internet address. It shall be appreciated that the received IP events can be classified based, at least in part, on the geographic location and/or area from which they were originated. Thus, the method 200 can further include correlating 206 the received Internet Protocol events—and specifically, the location information from the enriched Internet Protocol events—to the received geographic information and attributing 208 an Internet Protocol event to the entity based on the correlation.

Referring now to FIG. 3, a logic flow diagram of another method 300 of attributing a network-implemented cyber asset to an operating entity is depicted in accordance with at least one non-limiting aspect of the present disclosure. According to the non-limiting aspect of FIG. 3, the method 300 can begin with one or more IP events connected to an entity by means other than geographic information, and then considers supplemental information (e.g., location information) provided by one or more sources 1003 (FIG. 1) to attribute the operating entity to geographic information. Of course, the attribution of the entity to the geographic information can be used to attribute other IP addresses detected at those locations to the entity. However, this attribution can also be used to develop knowledge of known locations used by the entity and/or other unknown locations potentially used by the entity. In other words, the method 300 of FIG. 3 can be used to further develop geographic information associated with the entity, which can be used as an input to the method 200 of FIG. 2. Once again, the method 300 of FIG. 3 can be algorithmically implemented via the cyber risk management server 1002 of the system 1000 of FIG. 1.

According to the non-limiting aspect of FIG. 3, the method 300 can include receiving 302 Internet Protocol events known to be associated with an entity by means other than a geographic correlation. In other words, unlike the method 200 described in reference to FIG. 2, the method 300 of FIG. 3 begins with IP events that the cyber risk management server 1002 (FIG. 1) already knows to be associated with a particular entity. In that regard, according to some non-limiting aspects, the method 300 of FIG. 3 can also use outputs of the method 200 of FIG. 2 as an input.

Still referring to FIG. 3, the method 300 can further include receiving 304 supplemental information, such as location information, associated with the IP event associated entity received in the prior step. Once again, according to some non-limiting aspects, the cyber risk management server 1002 (FIG. 1) can receive the supplemental information from the source 1003 (FIG. 1). Based on the received supplemental information, the method 300 can further include determining 306 geographic information associated with the entity based on the received supplemental information. For example, based on the received supplemental information, the cyber risk management provider might determine that a first location is the headquarters of the entity and that a second location is a satellite office of the entity. According to another non-limiting aspect, the cyber risk management provider might be able to determine that a third location is an office of a parent organization or subsidiary of the entity. As such, the method 300 can include attributing 308 one or more additional IP events to the entity based on the determined geographic information associated with the entity. In other words, according to the method 300 of FIG. 3, the IP events received at step 302 are geographically enriched and associated to a particular location. The method 300 enables a cyber risk management server 1002 (FIG. 1) to connect the IP event and/or the particular location associated with the IP event to an entity based on the supplemental information received at step 304 and the determination made at step 306. For example, if the supplemental information provides corporate location information associated with the entity (e.g., a headquarter address of the entity, a satellite office address of the entity, etc.), the cyber risk management server 1002 (FIG. 1) might determine that a first IP event is associated with the determined headquarters of the entity and that a second IP event is associated with the determined satellite office of the entity via the method 300 of FIG. 3.

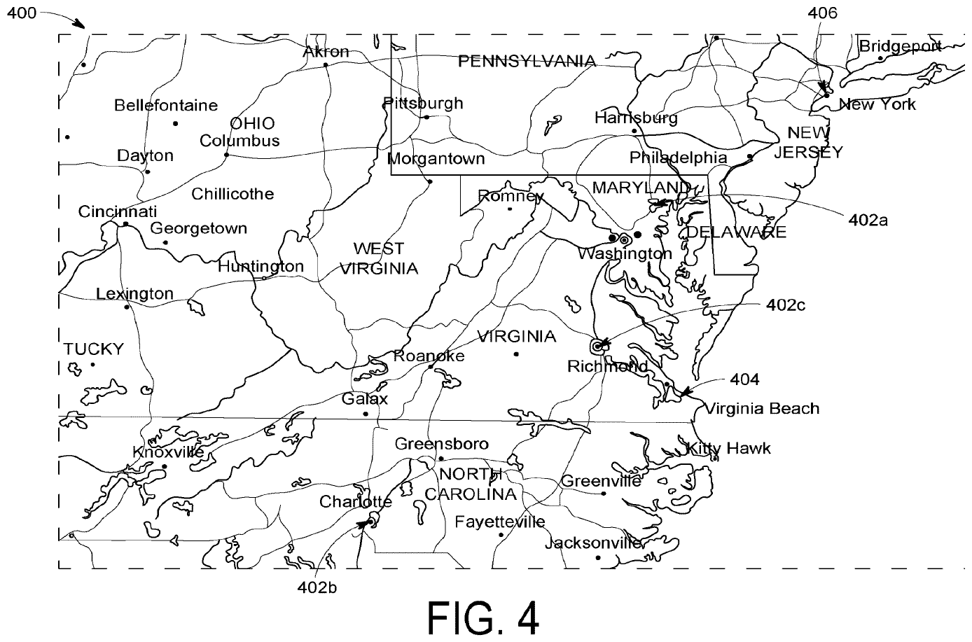

For example, as illustrated in FIG. 4, which will discussed in further detail herein, a user of the method 300 of FIG. 3 may suspect that an identified IP address is associated with an entity. The method 300 can be implemented to observe geographic information at the location of a headquarters of the suspected entity (e.g., Richmond) and/or a variety of satellite locations that align with what the entity's web page says about the entity's other locations.

It shall be further appreciated that each of the algorithmic methods 200, 300 of FIGS. 2 and 3 can be effective alone and/or in combination with the other. For example, as alluded to in specific reference to the method 300 of FIG. 3, the algorithmic methods 200, 300 of FIGS. 2 and 3 can be used iteratively. The first method 200 (FIG. 2) can be employed to attribute IP events (e.g., IP addresses) associated with a particular location of interest and entity associated with that location of interest. The second method 300 (FIG. 3) can be employed to determine alternate geographic locations of interest associated with an entity and/or IP events (e.g., IP addresses) associated with that entity. Accordingly, both algorithmic methods 200, 300 (FIGS. 2 and 3) can be iterated until the process stabilizes. Stabilization, for example, can be achieved when the methods 200, 300 (FIGS. 2 and 3) detect no new IP addresses and geographic locations. Alternately, stabilization can be achieved upon the expiration of a predetermined time limit or iteration limit, without the process achieving an otherwise stable conclusion.

Moreover, according to some non-limiting aspects, the methods 200, 300 of FIGS. 2 and 3 can be supplemented with the infusion of additional inputs. For example, the use of supplemental information (e.g., phone directories, building directories, building outlines, gazetteers, images and/or video data, etc.) can be acquired from external sources, such as the one or more sources 1003 of FIG. 1, to supplement and validate the outputs of the methods 200, 300 of FIGS. 2 and 3 and thus, establish more confidence in the generated results (e.g., determined locations of interest, determined entities associated with IP events, etc.). For example, the results generated by the methods 200, 300 of FIGS. 2 and 3 can be used as inputs for a query executed by the cyber risk management server 1002 (FIG. 1) via the network 1008 to produce supplemental information that includes, for example, registration information, public key certificates emitted by identified IP addresses, related hostnames, domains and subdomains with or without associated IP addresses, and/or wireless access point identification via Service Set Identifier (“SSID”), amongst others. According to some non-limiting aspects, the cyber risk management server 1002 (FIG. 1) may query the one or more sources 1003 (FIG. 1) for such information. According to other non-limiting aspects, the one or more sources 1003 (FIG. 1) can include data from the DNS, for example. Of course, the methods 200, 300 of FIGS. 2 and 3, types of supplemental information, and/or sources 1003 can be refined depending on user preference and/or intended application. For example, adjustments may be necessary to enable improved identification in a particular environment (e.g., a dense, highly-populated city, a more remote, rural town, etc.) For example, seeing an IP address which, from associated geographic information, appears to be in a multi-story building in downtown New York City, correct association to an entity may require further validation from one or more non-geographically oriented and possibly non-authoritative sources (e.g. a public key certificate, a telephone number associated via an IP or domain registration connected to the IP address, etc.) to provide conclusive evidence that the IP address belongs to a particular entity. In such cases the geographic information becomes supporting evidence that can be combined with other sources, which may themselves be non-authoritative or otherwise unreliable. On the other hand, for an IP address associated with a dairy farm in a rural area where there is only one IP address observed for many square miles, it may simply suffice to observe the IP address at the postal address of the dairy farm, to conclude with satisfactory confidence that the IP address is properly associated with the dairy farm. Furthermore, additional adjustments may be warranted to identify communications portals and/or pathways used specifically by otherwise challenging entities, such as an Internet Service Providers (“ISP”) and/or other Internet hosting companies. For example, such entities may introduce additional complexities into the footprinting process because they are simultaneously generating IP events associated with the corporate management of their business while managing communications to and from the various IP addresses provisioned to their customers. An Internet Service Provider (ISP) has both cyber assets it uses for its own purposes and which are generally relevant to performing a cyber security assessment, as well as cyber assets it provides, leases, or otherwise allocates to other entities. In such cases, it is important to tease apart the pieces of cyber space used exclusively by the ISP (e.g. the mail servers, VPNs, web servers, egress portals, gateways, proxies, etc.) versus those used by customers which are generally segregated from the elements used exclusively by the ISP. Here, the geographic addresses of the Internet Service providers may be used to distinguish the Internet assets actually used by the ISP from those allocated to the customer.

Referring now to FIG. 4, a graphical representation 400 of several outputs 402a-c, 404, 406 of the method 300 of FIG. 3 is depicted in accordance with at least one non-limiting aspect of the present disclosure. According to the non-limiting aspect of FIG. 4, the graphical representation 400 can include a map generated based on supplemental information (e.g., location information, such as geographic coordinates, street addresses, etc.) received by the cyber risk management server 1002 (FIG. 1). According to some non-limiting aspects, the geographic information can be provided by one or more sources 1003 (FIG. 1). The outputs 402a-c, 404, 406 of the method 300 of FIG. 3 can be overlaid upon the generated map of the graphical representation 400.

In further reference to FIG. 4, the outputs 402a-c, 404, 406 can represent one or more locations associated with the entity determined by the cyber risk management server 1002 (FIG. 1) based on the supplemental information. For example, based on the received geographic information, the cyber risk management server 1002 (FIG. 1) has generated several outputs 402a-c, wherein each output 402a-c corresponds to a determined satellite office of the entity associated with an IP event. A second output 404 can correspond to an office of a parent and/or subsidiary entity of the entity associated with the IP event. A third output 406 can correspond to a central office, or headquarters, of the entity associated with the IP event. As previously described, the cyber risk management server 1002 (FIG. 1) can use the generated the outputs 402a-c, 404, 406 of FIG. 4 to attribute the entity known to be associated with IP events or the IP events known to be associated with the entity to the one or more determined locations 402a-c, 404, 406 based on supplemental information received from one or more sources 1003 (FIG. 1).

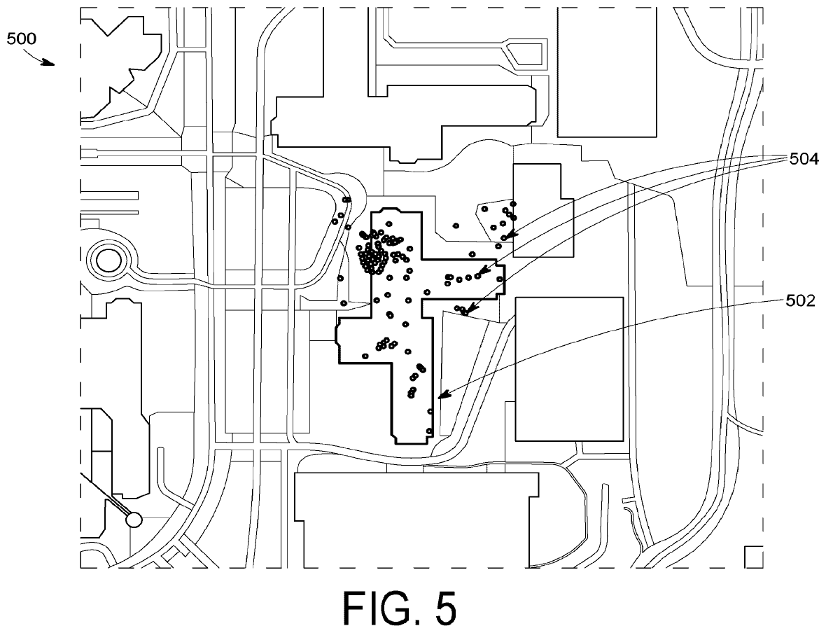

Referring now to FIG. 5, a graphical representation 500 of several outputs 502, 504 generated via either or both the methods 200, 300 of FIGS. 2 and 3 is depicted in accordance with at least one non-limiting aspect of the present disclosure. Similar to the non-limiting aspect of FIG. 4, the graphical representation 500 of FIG. 5 can include a map generated based on geographic information received by the cyber risk management server 1002 (FIG. 1). However, according to the non-limiting aspect of FIG. 5, the geographical information notably can include one or more outputs 502 associated building outlines or similar polygons, such as those provided by a source 1003 like Openstreetmaps.org, or an equivalent source of geographic information. As such, the graphical representation 500 of FIG. 5 can further include one or more outputs 504 associated with Internet Protocol events detected by the cyber risk management server 1002 (FIG. 1), which can be overlaid upon the generated map of the graphical representation 500.

It shall be appreciated that, although the outputs 502 of FIG. 5 that are associated with building outlines may not be necessary to effectively implement the methods 200, 300 of FIGS. 2 and 3, false positive determinations can be reduced by requiring the outputs 504 associated with IP events to fall within the boundaries defined by the outputs 502 associated with building outlines, wherein it is understood that the outlined building is associated with an entity of interest. Of course, according to some non-limiting aspects, such determinations may include IP events detected within a predetermined radius (e.g., as defined by latitudes and longitudes, northings and eastings, etc.) defined around one or more buildings owned by an entity of interest. The boundary can account for a margin of error, for example. Alternately, the boundary can account for outdoor accommodations associated with the building, commuters, or personnel on break or traveling across a campus that includes numerous buildings. In other words, IP events that fall within a predetermined circle, box, and/or polygon that circumscribes one or more buildings known to be associated with an entity of interest may be attributed to the entity of interest, even if their respective outputs 504 do not fall within any of the building outlines, themselves. According to some non-limiting aspects, even just a portion of a building can be considered based on supplemental information. For example, based on supplemental information, it may be determined that an entity rents office space in the north side of a building. Referring now to FIG. 6, a block diagram of a computing system 9000 is depicted in accordance with at least one non-limiting aspect of the present disclosure. The computing system 9000 and the various components comprised therein, as described below, may be used to implement various components of the system 1000 described hereinabove in connection with FIG. 1 and/or may be used to store and execute instructions for any of the various process described hereinabove in connection with FIGS. 2-4A and 4B. According to the non-limiting aspect of FIG. 6, the computer system 9000 may include a bus 9002 (i.e., interconnect), one or more processors 9004, a main memory 9006, read-only memory 9008, removable storage media 9010, mass storage 9012, and one or more communications ports 9014. As should be appreciated, components such as removable storage media are optional and are not necessary in all systems. Communication port 9014 may be connected to one or more networks by way of which the computer system 9000 may receive and/or transmit data.

As used herein, a “processor” can mean one or more microprocessors, central processing units (CPUs), computing devices, microcontrollers, digital signal processors, graphics processing units (GPUs) or like devices or any combination thereof, regardless of their architecture. An apparatus that performs a process can include, e.g., a processor and those devices such as input devices and output devices that are appropriate to perform the process. Processor(s) 9004 can be any known processor, such as, but not limited to, processors manufactured by and/or sold by INTEL®, AMD®, or MOTOROLA®, and the like, that are generally well-known to one skilled in the relevant art and are well-defined in the literature. Communications port(s) 9014 can be any of an RS-232 port for use with a modem based dial-up connection, a 10/100 Ethernet port, a Gigabit port using copper or fiber, or a USB port, and the like. Communications port(s) 9014 may be chosen depending on a network such as a Local Area Network (LAN), a Wide Area Network (WAN), a CDN, or any network to which the computer system 9000 connects. The computer system 9000 may be in communication with peripheral devices (e.g., display screen 9016, input device(s) 9018) via Input/Output (I/O) port 9020.

Main memory 9006 can be Random Access Memory (RAM), or any other dynamic storage device(s) commonly known in the art. Read-only memory 9008 can be any static storage device(s) such as Programmable Read-Only Memory (PROM) chips for storing static information such as instructions for processor 9004. Mass storage 9012 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 9002 communicatively couples processor(s) 9004 with the other memory, storage, and communications blocks. Bus 9002 can be a PCI/PCI-X, SCSI, a Universal Serial Bus (USB) based system bus (or other) depending on the storage devices used, and the like. Removable storage media 9010 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Aspects described herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (“RF”) and infrared (IR) data communications.

The machine-readable medium may include, but is not limited to, floppy diskettes, optical discs, CD-ROMs, magneto-optical disks, ROMs, RAMs, erasable programmable read-only memories (“EPROMs”), electrically erasable programmable read-only memories (“EEPROMs”), magnetic or optical cards, flash memory, or other type of media/machine-readable medium suitable for storing electronic instructions. Moreover, aspects described herein may also be downloaded as a computer program product, wherein the program may be transferred from a remote computer to a requesting computer by way of data signals embodied in a carrier wave or other propagation medium via a communication link (e.g., modem or network connection). Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods. As shown, main memory 9006 is encoded with application(s) 9022 that supports the functionality discussed herein (the application 9022 may be an application that provides some or all of the functionality of the CD services described herein, including the client application). Application(s) 9022 (and/or other resources as described herein) can be embodied as software code such as data and/or logic instructions (e.g., code stored in the memory or on another computer readable medium such as a disk) that supports processing functionality according to different aspects described herein.

During operation of one aspect, processor(s) 9004 accesses main memory 9006 via the use of bus 9002 in order to launch, run, execute, interpret or otherwise perform the logic instructions of the application(s) 9022. Execution of application(s) 9022 produces processing functionality of the service related to the application(s). In other words, the process(es) 9024 represents one or more portions of the application(s) 9022 performing within or upon the processor(s) 9004 in the computer system 9000. It should be noted that, in addition to the process(es) 9024 that carries (carry) out operations as discussed herein, other processes described herein include the application 9022 itself (i.e., the un-executed or non-performing logic instructions and/or data). The application 9022 may be stored on a computer readable medium (e.g., a source) such as a disk or in an optical medium. According to other aspects, the application 9022 can also be stored in a memory type system such as in firmware, read only memory (ROM), or, as in this example, as executable code within the main memory 9006 (e.g., within Random Access Memory or RAM). For example, application 9022 may also be stored in removable storage media 9010, read-only memory 9008 and/or mass storage device 9012.

It shall be further appreciated that the devices, systems, and methods disclosed herein can be complementary to and advantageously combined with the devices, systems, and methods disclosed in U.S. Provisional Patent Application No. 63/313,422 titled DEVICES, SYSTEMS, AND METHODS FOR IDENTIFYING CYBER ASSETS AND GENERATING CYBER RISK MITIGATION ACTION BASED ON DOMAIN REDIRECTS, filed on Feb. 24, 2022, the disclosure of each of which is herein incorporated by reference in its entirety. Specifically, it shall be appreciated that, in combination with the identification of a cyber asset based on a domain, the accurate attribution of a network implemented cyber asset to an operating entity can produce valuable cyber security insights, which can be employed to generate enhanced cyber risk mitigation actions. For example, the threat exposure of a given cyber asset configuration may be time-dependent and/or may vary depending on the occurrence of various cyber events. Thus, investigating IP events associated with a particular cyber asset for cyber threats via the devices, systems, and methods described herein can expeditiously mitigate the exploitation risk.

According to some non-limiting aspects, the algorithm or algorithms for investigating a cyber asset and IP event for cyber threats can include the autonomous generation of one or more cyber risk mitigation actions based on the attribution of network-implemented cyber assets to an operating entities via the methods 200 (FIG. 2), 300 (FIG. 3) disclosed herein. Generating a cyber risk mitigation action can include, for example, generating entity cyber security risk reports, generating a cyber asset threat database including the cyber assets attributed to a particular operating entity and/or an identified network associated with that entity, implementing a remediation action, and generating an alert (collectively “cyber risk mitigation actions”). For example, in various aspects, generating a cyber risk mitigation action can include generating entity cyber security risk reports. The entity cyber security risk reports can include one or more reports, each report comprising an evaluation of the cyber threat exposure of one or more entities in an entity database based on the results of the methods and processes deployed by the cyber risk management server 1002 (FIG. 1). The risk reports can include a risk level score that can be used by the cyber risk management provider to determine the relative risk level of a particular entity compared to other entities in an entity database.

According to other non-limiting aspects, generating a cyber risk mitigation action can include generating an entities' cyber asset threat, vulnerability, and risk database. The cyber asset threat, vulnerability, and risk database can include a log of each of the assets from cyber asset databases that has been identified as being exposed to a cyber threat, vulnerability, and/or risk. The cyber asset threat, vulnerability, and risk database or portions thereof may be referenced by the cyber risk management provider when making asset management decisions. For example, the cyber asset threat, vulnerability, and risk database can be used to identify cyber assets that need configuration updates. According to still other non-limiting aspects, generating a cyber risk mitigation action can comprise implementing a remediation action. In some aspects, implementing a remediation action can comprise executing an algorithm that causes an automated configuration update to one or more of the cyber assets identified as exposed to a cyber threat at. For example, implementing a remediation action can comprise implementing a remediated configuration based on an email-related cyber threat, implementing a remediated configuration based on a host configuration-related cyber threat, and/or implementing a remediated configuration based on a traffic-related cyber threat.

In still other non-limiting aspects, generating a cyber risk mitigation action can include generating an alert in response to identifying one or more cyber assets as being exposed to a cyber threat at. For example, in one aspect, an alert may be sent to a security analyst of the cyber risk management provider and/or other parties charged with managing the cyber security of a particular entity. In other aspects, an alert may be sent to a cyber asset or the user of a cyber asset associated with an identified cyber threat. The alert generated at step can comprise instructions for the security analyst, user, or other party to take a specific action in response to an identified cyber threat. In another aspect, the alert can also take the form of an automated control instruction to computer systems providing security services, for example a control message closing a port could be sent to an entity's firewall upon seeing evidence of malicious activity performed by a malicious actor. According to still other non-limiting aspects, an alert can be generated including a message indicating, for example, an insecure host configuration has been detected, a computer using an insecure host configuration has been used to send or receive information, and/or a IP event associated with a cyber asset using an insecure host configuration has been communicated with.

It shall be further appreciated that the cyber risk management server 1002 (FIG. 1) can be configured to autonomously and continuously execute the methods 200 (FIG. 2), 300 (FIG. 3), and processes 600 (FIG. 6), 700 (FIG. 7) disclosed herein. Accordingly, although it would be highly impractical—if not impossible—for a cyber risk management provider to perform the methods 200 (FIG. 2), 300 (FIG. 3), and processes 600 (FIG. 6), 700 (FIG. 7) disclosed herein manually, or without the assistance of the system 1000 of FIG. 1. Moreover, the continuous and autonomous capabilities of the system 1000 of FIG. 1 enable technological benefits in the form of enhanced cyber security on behalf of the tenant entities 1010₁₋ₙ. For example, the methods 200 (FIG. 2), 300 (FIG. 3), and processes 600 (FIG. 6), 700 (FIG. 7) disclosed herein enable the cyber risk management server 1002 (FIG. 1) to autonomously implement a remediated security configuration for a tenant entity 1010₁₋ₙ. As previously discussed, the remediated configuration can be based on an email-related cyber threat, a host configuration-related cyber threat, and/or a traffic-related cyber threat.

Various aspects of the subject matter described herein are set out in the following numbered clauses:
Clause 1. A cyber risk management server configured to attribute a network-implemented cyber asset to an operating entity and enhance cyber security of a tenant entity based on the attribution, the cyber risk management server including a processor communicably coupled to the tenant entity and a source configured to store geographic information, and a memory configured to store algorithmic instructions that, when executed by the processor, cause the cyber risk management server to receive the geographic information from the source, receive a plurality of Internet Protocol (“IP”) events associated with a plurality of cyber assets, wherein the IP events are enriched with location information, correlate a first IP event of the plurality of IP events with the received geographic information, attribute the first IP event to the operating entity based on the correlation, and generate a cyber risk mitigation action for the tenant entity, wherein the cyber risk mitigation action is configured to enhance the cyber security of the tenant entity based on the attribution of the first IP event to the operating entity.
Clause 2. The cyber risk management server according to clause 1, wherein, when executed by the processor, the instructions further cause the cyber risk management server to determine one or more locations associated with the entity based on the received geographic information, and attribute at least a first subset of the plurality of IP events to the operating entity based on the one or more determined locations, and wherein the generation of the cyber risk mitigation action is configured to enhance the cyber security of the tenant entity based on the attribution of the at least a first subset of the plurality of IP events to the operating entity.
Clause 3. The cyber risk management server according to either of clauses 1 or 2, wherein, when executed by the processor, the instructions further cause the cyber risk management server to identify a boundary based on the received geographic information, determine that at least one second subset of the plurality of IP events originated within the generated boundary, and attribute the second subset of the plurality of IP events to the operating entity based on the determination that the at least a second subset of the plurality of IP events originated within the generated boundary, and wherein the generation of the cyber risk mitigation action is configured to enhance the cyber security of the tenant entity based on the attribution of the at least one second subset of the plurality of IP events to the operating entity.
Clause 4. The cyber risk management server according to any of clauses 1-3, wherein, when executed by the processor, the instructions further cause the cyber risk management server to determine that at least one third subset of the plurality of IP events originated outside of the generated boundary, and determine that the third subset of the plurality of IP events should be excluded from the geographic-based attribution based on the determination that the at least one third subset of the plurality of IP events originated outside of the generated boundary.
Clause 5. The cyber risk management server according to any of clauses 1-4, wherein each cyber asset of the plurality of cyber assets is configured to connect to a network of a plurality of networks, and wherein the connection of each cyber asset of the plurality of cyber assets to the network of the plurality of networks is defined by an IP address and network identifying information.
Clause 6. The cyber risk management server according to any of clauses 1-5, wherein the geographic information includes at least one of a geographic coordinate, a street address, and a building outline, a boundary, or combinations thereof.
Clause 7. The cyber risk management server according to any of clauses 1-6, wherein the tenant entity is a first tenant entity of a plurality of tenant entities communicably coupled to the processor, and wherein, when executed by the processor, the instructions further cause the cyber risk management server to continuously and autonomously generate a plurality of cyber risk mitigation actions, wherein each cyber risk mitigation action is configured to enhance the cyber security of a tenant entity of the plurality of tenant entities based on the attribution.
Clause 8. The cyber risk management server according to any of clauses 1-7, wherein the cyber risk mitigation action includes a remediated host configuration, and wherein the method further includes automatically implementing, via the processor, the remediated host configuration.
Clause 9. The cyber risk management server according to any of clauses 1-8, wherein the cyber risk mitigation action includes a remediated host configuration, and wherein the method further includes automatically implementing, via the processor, the remediated host configuration.
Clause 10. The cyber risk management server according to any of clauses 1-9, wherein the cyber risk mitigation action includes a remediated email configuration, and wherein the method further includes automatically implementing the remediated email configuration.
Clause 11. The cyber risk management server according to any of clauses 1-10, wherein the IP events are enriched with location information via a second source.
Clause 12. The cyber risk management server according to any of clauses 1-11, further including enriching the IP events with the location information.
13. A computer-implemented method of attributing a network-implemented cyber asset to an operating entity and enhancing cyber security of a tenant entity based on the attribution via a cyber risk management server, the method including receiving, via a processor of the cyber risk management server, geographic information from a source, receiving, via the processor, a plurality of Internet Protocol (“IP”) events associated with a plurality of cyber assets, wherein the IP events are enriched with location information, correlating, via the processor, an IP event of the plurality of IP events with the received geographic information, attributing, via the processor, the IP event to the operating entity based on the correlation, and generating, via the processor, a cyber risk mitigation action for the tenant entity, wherein the cyber risk mitigation action is configured to enhance the cyber security of the tenant entity based on the attribution of the IP event to the operating entity.
Clause 14. The computer-implemented method according to clause 13, further including determining, via the processor, one or more locations associated with the entity based on the received geographic information, and attributing, via the processor, at least a first subset of the plurality of IP events to the operating entity based on the one or more determined locations, and wherein the generation of the cyber risk mitigation action is configured to enhance the cyber security of the tenant entity based on the attribution.
Clause 15. The computer-implemented method according to either of clauses 13or 14, further including generating, via the processor, a boundary based on the received geographic information, and determining, via the processor, that at least a second subset of the plurality of IP events originated within the generated boundary, and attributing, via the processor, the second subset of the plurality of IP events to the operating entity based on the determination that the at least a second subset of the plurality of IP events originated within the generated boundary, and wherein the generation of the cyber risk mitigation action is configured to enhance the cyber security of the tenant entity based on the attribution of the at least a second subset of the plurality of IP events to the operating entity.
Clause 16. The computer-implemented method according to any of clauses 13-15, further including determining, via the processor, that at least a third subset of the plurality of IP events originated outside of the generated boundary, and determining, via the processor, that the third subset of the plurality of IP events should be excluded from the geographic-based attribution based on the determination that the at least a third subset of the plurality of IP events originated outside of the generated boundary.
Clause 17. A system configured to attribute a network-implemented cyber asset to an operating entity and enhance cyber security of a tenant entity based on the attribution, system including a source configured to store geographic information, and a cyber risk management server including a processor communicably coupled to the tenant entity the source, and a memory configured to store algorithmic instructions that, when executed by the processor, cause the cyber risk management server to receive the geographic information from the source, receive a plurality of Internet Protocol (“IP”) events associated with a plurality of cyber assets, wherein the IP events are enriched with location information, correlate a first IP event of the plurality of IP events with the received geographic information, attribute the first IP event to the operating entity based on the correlation, and generate a cyber risk mitigation action for the tenant entity, wherein the cyber risk mitigation action is configured to enhance the cyber security of the tenant entity based on the attribution of the IP event to the operating entity.
Clause 18. The system according to clause 17, wherein, when executed by the processor, the instructions further cause the cyber risk management server to determine one or more locations associated with the entity based on the received geographic information, and attribute at least a first subset of the plurality of IP events to the operating entity based on the one or more determined locations, and wherein the generation of the cyber risk mitigation action is configured to enhance the cyber security of the tenant entity based on the attribution of the at least a first subset of the plurality of IP events to the operating entity.
Clause 19. The system according to either of clauses 17 or 18, wherein, when executed by the processor, the instructions further cause the cyber risk management server to identify a boundary based on the received geographic information, determine that at least a second subset of the plurality of IP events originated within the generated boundary, and attribute the second subset of the plurality of IP events to the operating entity based on the determination that the at least a second subset of the plurality of IP events originated within the generated boundary, and wherein the generation of the cyber risk mitigation action is configured to enhance the cyber security of the tenant entity based on the attribution of the at least a second subset of the plurality of IP events to the operating entity.
Clause 20. The system according to any of clauses 17-19, wherein, when executed by the processor, the instructions further cause the cyber risk management server to determine that at least a third subset of the plurality of IP events originated outside of the generated boundary, and determine that the third subset of the plurality of IP events should be excluded from the geographic-based attribution based on the determination that the at least a third subset of the plurality of IP events originated outside of the generated boundary.
Clause 21. A computer-implemented method of attributing a network-implemented cyber asset to an operating entity and enhancing cyber security of a tenant entity based on the attribution via a cyber risk management server, the method including receiving, via a processor of the cyber risk management server, an Internet Protocol (“IP”) event associated with an operating entity by means other than a geographic correlation from a source, wherein the IP event is enriched with location information, receiving, via the processor, supplemental location information associated with the IP event associated entity, determining, via the processor, geographic information associated with the entity based on the received supplemental location information, attributing, via the processor, at least one more IP event to the entity based on the determined geographic information associated with the entity, identifying, via the processor, alternate geographic locations also associated to the entity based on geographic data connected to at least one IP address associated with an operating entity by means other than a geographic correlation, identifying, via the processor, alternate IP events associated with the entity based on the alternate geographic locations, thereby validating an association of the alternate geographic locations to the entity, and generating, via the processor, a cyber risk mitigation action for the tenant entity, wherein the cyber risk mitigation action is configured to enhance the cyber security of the tenant entity based on the attribution of the at least one more IP event to the entity.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference, and the disclosure expressly set forth in the present application controls.

Various exemplary, and illustrative aspects have been described. The aspects described herein are understood as providing illustrative features of varying detail of various aspects of the present disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure. Accordingly, it will be recognized by persons having ordinary skill in the art that various substitutions, modifications, or combinations of any of the exemplary aspects may be made without departing from the scope of the claimed subject matter. In addition, persons skilled in the art will recognize, or be able to ascertain using no more than routine experimentation, many equivalents to the various aspects of the present disclosure upon review of this specification. Thus, the present disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”, and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one”, and indefinite articles such as “a” or “an” (e.g., “a”, and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A, and B together, A, and C together, B, and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A, and B together, A, and C together, B, and C together, and/or A, B, and C together, etc.). It will be further understood by those within the art that typically a disjunctive word, and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A, and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,”, and the like means that a particular feature, structure, or characteristic described in connection with the aspect is included in at least one aspect. Thus, appearances of the phrases “in one aspect,” “in an aspect,” “in an exemplification,”, and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example, and without limitation, top, bottom, left, right, lower, upper, front, back, and variations thereof, shall relate to the orientation of the elements shown in the accompanying drawing, and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced, and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits, and by applying ordinary rounding techniques.

Any numerical range recited herein includes all sub-ranges subsumed within the recited range. For example, a range of “1 to 100” includes all sub-ranges between (and including) the recited minimum value of 1, and the recited maximum value of 100, that is, having a minimum value equal to or greater than 1, and a maximum value equal to or less than 100. Also, all ranges recited herein are inclusive of the end points of the recited ranges. For example, a range of “1 to 100” includes the end points 1, and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification, and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material, and the existing disclosure material.

The terms “comprise” (and any form of comprise, such as “comprises”, and “comprising”), “have” (and any form of have, such as “has”, and “having”), “include” (and any form of include, such as “includes”, and “including”), and “contain” (and any form of contain, such as “contains”, and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The foregoing detailed description has set forth various forms of the devices, and/or processes via the use of block diagrams, flowcharts, and/or examples. Insofar as such block diagrams, flowcharts, and/or examples contain one or more functions, and/or operations, it will be understood by those within the art that each function, and/or operation within such block diagrams, flowcharts, and/or examples can be implemented, individually, and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry, and/or writing the code for the software, and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (“DRAM”), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (“CD-ROMs”), and magneto-optical disks, read-only memory (“ROMs”), random access memory (“RAM”), erasable programmable read-only memory (“EPROM”), electrically erasable programmable read-only memory (“EEPROM”), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, digital signal processor (“DSP”), programmable logic device (“PLD”), programmable logic array (“PLA”), or field programmable gate array (“FPGA”), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (“ASIC”), a system on-chip (“SoC”), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes, and/or devices described herein, or a microprocessor configured by a computer program which at least partially carries out processes, and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations. Software may be embodied as a software package, code, instructions, instruction sets, and/or data recorded on non-transitory computer readable storage medium. Firmware may be embodied as code, instructions or instruction sets, and/or data that are hard-coded (e.g., nonvolatile) in memory devices.

As used in any aspect herein, the terms “component,” “system,” “module”, and the like can refer to a computer-related entity, either hardware, a combination of hardware, and software, software, or software in execution.

As used in any aspect herein, an “algorithm” refers to a self-consistent sequence of steps leading to a desired result, where a “step” refers to a manipulation of physical quantities, and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These, and similar terms may be associated with the appropriate physical quantities, and are merely convenient labels applied to these quantities, and/or states.

1. A cyber risk management server configured to attribute a network-implemented cyber asset to an operating entity and enhance cyber security of a tenant entity based on the attribution, the cyber risk management server comprising:
a processor communicably coupled to the tenant entity and a source configured to store geographic information; and
a memory configured to store algorithmic instructions that, when executed by the processor, cause the cyber risk management server to:
receive the geographic information from the source;
receive a plurality of Internet Protocol (“IP”) events associated with a plurality of cyber assets, wherein the IP events are enriched with location information;
correlate a first IP event of the plurality of IP events with the received geographic information;
attribute the first IP event to the operating entity based on the correlation; and
generate a cyber risk mitigation action for the tenant entity, wherein the cyber risk mitigation action is configured to enhance the cyber security of the tenant entity based on the attribution of the first IP event to the operating entity.

2. The cyber risk management server of claim 1, wherein, when executed by the processor, the instructions further cause the cyber risk management server to:
determine one or more locations associated with the entity based on the received geographic information; and
attribute at least a first subset of the plurality of IP events to the operating entity based on the one or more determined locations, and wherein the generation of the cyber risk mitigation action is configured to enhance the cyber security of the tenant entity based on the attribution of the at least a first subset of the plurality of IP events to the operating entity.

3. The cyber risk management server of claim 2, wherein, when executed by the processor, the instructions further cause the cyber risk management server to:
identify a boundary based on the received geographic information;
determine that at least one second subset of the plurality of IP events originated within the generated boundary; and
attribute the second subset of the plurality of IP events to the operating entity based on the determination that the at least a second subset of the plurality of IP events originated within the generated boundary, and wherein the generation of the cyber risk mitigation action is configured to enhance the cyber security of the tenant entity based on the attribution of the at least one second subset of the plurality of IP events to the operating entity.

4. The cyber risk management server of claim 3, wherein, when executed by the processor, the instructions further cause the cyber risk management server to:
determine that at least one third subset of the plurality of IP events originated outside of the generated boundary; and
determine that the third subset of the plurality of IP events should be excluded from the geographic-based attribution based on the determination that the at least one third subset of the plurality of IP events originated outside of the generated boundary.

5. The cyber risk management server of claim 3, wherein each cyber asset of the plurality of cyber assets is configured to connect to a network of a plurality of networks, and wherein the connection of each cyber asset of the plurality of cyber assets to the network of the plurality of networks is defined by an IP address and network identifying information.

6. The cyber risk management server of claim 1, wherein the geographic information comprises at least one of a geographic coordinate, a street address, and a building outline, a boundary, or combinations thereof.

7. The cyber risk management server of claim 1, wherein the tenant entity is a first tenant entity of a plurality of tenant entities communicably coupled to the processor, and wherein, when executed by the processor, the instructions further cause the cyber risk management server to continuously and autonomously generate a plurality of cyber risk mitigation actions, wherein each cyber risk mitigation action is configured to enhance the cyber security of a tenant entity of the plurality of tenant entities based on the attribution.

8. The computer-implemented method of claim 1, wherein the cyber risk mitigation action comprises a remediated host configuration, and wherein the method further comprises automatically implementing, via the processor, the remediated host configuration.

9. The computer-implemented method of claim 1, wherein the cyber risk mitigation action comprises a remediated host configuration, and wherein the method further comprises automatically implementing, via the processor, the remediated host configuration.

10. The computer-implemented method of claim 1, wherein the cyber risk mitigation action comprises a remediated email configuration, and wherein the method further comprises automatically implementing the remediated email configuration.

11. The computer-implemented method of claim 1, wherein the IP events are enriched with location information via a second source.

12. The computer-implemented method of claim 1, further comprising enriching the IP events with the location information.

13. A computer-implemented method of attributing a network-implemented cyber asset to an operating entity and enhancing cyber security of a tenant entity based on the attribution via a cyber risk management server, the method comprising:
receiving, via a processor of the cyber risk management server, geographic information from a source;
receiving, via the processor, a plurality of Internet Protocol (“IP”) events associated with a plurality of cyber assets, wherein the IP events are enriched with location information;
correlating, via the processor, an IP event of the plurality of IP events with the received geographic information;
attributing, via the processor, the IP event to the operating entity based on the correlation; and
generating, via the processor, a cyber risk mitigation action for the tenant entity, wherein the cyber risk mitigation action is configured to enhance the cyber security of the tenant entity based on the attribution of the IP event to the operating entity.

14. The computer-implemented method of claim 13, further comprising:
determining, via the processor, one or more locations associated with the entity based on the received geographic information; and
attributing, via the processor, at least a first subset of the plurality of IP events to the operating entity based on the one or more determined locations, and wherein the generation of the cyber risk mitigation action is configured to enhance the cyber security of the tenant entity based on the attribution.

15. The computer-implemented method of claim 14, further comprising:
generating, via the processor, a boundary based on the received geographic information; and
determining, via the processor, that at least a second subset of the plurality of IP events originated within the generated boundary; and
attributing, via the processor, the second subset of the plurality of IP events to the operating entity based on the determination that the at least a second subset of the plurality of IP events originated within the generated boundary, and wherein the generation of the cyber risk mitigation action is configured to enhance the cyber security of the tenant entity based on the attribution of the at least a second subset of the plurality of IP events to the operating entity.

16. The computer-implemented method of claim 15, further comprising:
determining, via the processor, that at least a third subset of the plurality of IP events originated outside of the generated boundary; and
determining, via the processor, that the third subset of the plurality of IP events should be excluded from the geographic-based attribution based on the determination that the at least a third subset of the plurality of IP events originated outside of the generated boundary.

17. A system configured to attribute a network-implemented cyber asset to an operating entity and enhance cyber security of a tenant entity based on the attribution, system comprising:
a source configured to store geographic information; and
a cyber risk management server comprising:
a processor communicably coupled to the tenant entity the source; and
a memory configured to store algorithmic instructions that, when executed by the processor, cause the cyber risk management server to:
receive the geographic information from the source;
receive a plurality of Internet Protocol (“IP”) events associated with a plurality of cyber assets, wherein the IP events are enriched with location information;
correlate a first IP event of the plurality of IP events with the received geographic information;
attribute the first IP event to the operating entity based on the correlation; and
generate a cyber risk mitigation action for the tenant entity, wherein the cyber risk mitigation action is configured to enhance the cyber security of the tenant entity based on the attribution of the IP event to the operating entity.

18. The system of claim 17, wherein, when executed by the processor, the instructions further cause the cyber risk management server to:
determine one or more locations associated with the entity based on the received geographic information; and
attribute at least a first subset of the plurality of IP events to the operating entity based on the one or more determined locations, and wherein the generation of the cyber risk mitigation action is configured to enhance the cyber security of the tenant entity based on the attribution of the at least a first subset of the plurality of IP events to the operating entity.

19. The system of claim 18, wherein, when executed by the processor, the instructions further cause the cyber risk management server to:
identify a boundary based on the received geographic information;
determine that at least a second subset of the plurality of IP events originated within the generated boundary; and
attribute the second subset of the plurality of IP events to the operating entity based on the determination that the at least a second subset of the plurality of IP events originated within the generated boundary, and wherein the generation of the cyber risk mitigation action is configured to enhance the cyber security of the tenant entity based on the attribution of the at least a second subset of the plurality of IP events to the operating entity.

20. The system of claim 19, wherein, when executed by the processor, the instructions further cause the cyber risk management server to:
determine that at least a third subset of the plurality of IP events originated outside of the generated boundary; and
determine that the third subset of the plurality of IP events should be excluded from the geographic-based attribution based on the determination that the at least a third subset of the plurality of IP events originated outside of the generated boundary.

21. A computer-implemented method of attributing a network-implemented cyber asset to an operating entity and enhancing cyber security of a tenant entity based on the attribution via a cyber risk management server, the method comprising:
receiving, via a processor of the cyber risk management server, an Internet Protocol (“IP”) event associated with an operating entity by means other than a geographic correlation from a source, wherein the IP event is enriched with location information;
receiving, via the processor, supplemental location information associated with the IP event associated entity;
determining, via the processor, geographic information associated with the entity based on the received supplemental location information;
attributing, via the processor, at least one more IP event to the entity based on the determined geographic information associated with the entity;
identifying, via the processor, alternate geographic locations also associated to the entity based on geographic data connected to at least one IP address associated with an operating entity by means other than a geographic correlation;
identifying, via the processor, alternate IP events associated with the entity based on the alternate geographic locations, thereby validating an association of the alternate geographic locations to the entity; and
generating, via the processor, a cyber risk mitigation action for the tenant entity, wherein the cyber risk mitigation action is configured to enhance the cyber security of the tenant entity based on the attribution of the at least one more IP event to the entity.
